(19) United States
(12) Patent Application Publication
(10) Pub. No.: US 2006/0028174 A1
(43) Pub. Date: Feb. 9, 2006

(54) Battery pack and charger for portable electronic devices

(76) Inventor: Ta Jung Hsiao, Taipei City (TW)

Correspondence Address: Warren P. Kujawa, 461 Indigo Springs St., Henderson, NV, 89014, US

(21) Appl. No.: 10/913,905

(22) Filed: Aug. 7, 2004

(51) Int. Cl. H02J 7/00

(52) U.S. Cl. 320/112

(57) ABSTRACT

A combination battery pack/battery charger unit for use with a portable electronic device with an internal rechargeable battery. The battery pack/charger unit has a power input connector for receiving external D.C. power, a power output connector for supplying D.C. power to the portable electronic device, a power converter/transformer for converting unregulated D.C. input power to regulated D.C. power, a first direct power path between the converter/transformer and the power output connector, a three position switch, and a rechargeable battery connected between the input connector and the switch. LED indicators display the charging mode and the discharging mode. A high intensity LED coupled to the battery via the switch provides a flashlight mode. The unit provides recharging capability for the internal battery of the portable electronic device and extends the active use time of the portable electronic device.

### BACKGROUND OF THE INVENTION

This invention relates generally to portable electronic devices, such as personal digital assistants (PDAs), cellular telephones, portable music players, such as the music player sold under the trademark iPOD available from Apple Computer Corporation, and other battery-powered devices. More particularly, this invention relates to a supplemental battery pack and battery charger for portable electronic devices.

Many different types of portable electronic devices are known which are powered by an internal, rechargeable battery. Such devices currently enjoy wide popularity due to their portability and functional capabilities enabling users to conduct wireless telephone communications, initiate and respond to wireless digital data exchanges, and store and listen privately to a personal library of musical works at their own convenience, anywhere, anytime.

Due to the small form factor usually chosen by the designers of such devices, the physical size of the internal battery is limited to one having the capacity to store an amount of electrical charge capable of powering the device for only a limited amount of active use time, after which the battery must be re-charged. For example, in the case of portable music players, the maximum playing time provided by a new battery in the most popular device available today is only eight hours, which many users find inadequate for their purposes. As the battery deteriorates with time and use, the maximum active use time provided by a new battery diminishes. At some point, the battery must be replaced.

This limited active use time is the most common complaint voiced by users of current portable electronic devices. Many consumers use their portable electronic devices during long commutes or long travel periods. Others encounter conditions of use which do not provide access to the electrical power source required to recharge the internal battery (for example, during a camping trip lasting several days in an area where electrical power is unavailable). Most users would prefer that the active use time be extended well beyond the limited maximum.

One known solution to this problem of limited maximum active use time is an external battery pack which has power outputs connectable to the power input jack provided for portable electronic devices. This solution provides extended active use time up to several hours. One such battery pack available from Battery Technology, Inc. claims to provide up to forty hours of playing time or download time for a portable music player. This battery pack, however, does not charge the internal battery of the music player device.

### SUMMARY OF THE INVENTION

The invention comprises a combination battery pack and internal battery charger for a portable electronic device which extends the active use time of the device and also provides a recharging capability for the internal battery

In a broadest aspect, the invention comprises a combination supplemental battery pack and battery charger unit for use with an associated portable electronic device having an electrical power input. The unit comprises a power input connector adapted to be coupled to an external source of electrical power; a power output connector adapted to be coupled to a power input of an associated portable electronic device; a converter/transformer circuit coupled to the power input connector for converting D.C. power received by the power input connector and varying over a preselected D.C. voltage range to D.C. voltage lying within a preselected narrow voltage range; a first conductive path extending between the converter/transformer circuit and the power output connector; a switch having a movable contact and three stationary contacts, a first one of the three stationary contacts being connected to the first conductive path, a second one of the three stationary contacts being an open connection; a second conductive path coupled to the converter/transformer circuit; and a rechargeable battery having an input connected to the second conductive path, and an output coupled to the movable contact of the switch.

When the rechargeable battery is connected to an external source of electrical power, the external power recharges the rechargeable battery along one internal path, regardless of the position of the switch. If an associated electronic device is connected to the unit during recharging, D.C. power is supplied from the external power source to both the electronic device along the first conductive path and to the rechargeable battery along the second conductive path to simultaneously operate the electronic device and charge the battery.

If the rechargeable battery is connected to the power output connector when the movable contact of the switch is placed in contact with the first one of the three stationary contacts, supplemental D.C. electrical power is supplied to an associated portable electronic device connected to the power output connector, which results in extended active use time for the portable electronic device.

The invention further includes a visible indicator, preferably an amber colored LED, coupled to the first conductive path for providing a visible discharge indication when electrical power is flowing to the power output connector.

The invention further includes another visible indicator, preferably a green colored LED, coupled to the rechargeable battery for providing a visible indication when the rechargeable battery is undergoing recharge.

The invention optionally includes a high intensity light source, preferably a high intensity LED, coupled to a third one of the three stationary contacts of the switch to function as a flashlight when the movable contact of the switch is placed in contact with the third stationary contact to connect the rechargeable battery to the high intensity light source.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram of the preferred embodiment of the invention;

FIG. 2 is a block diagram of the converter/transformer circuit of the embodiment of FIG. 1;

FIG. 3 is a schematic view showing the embodiment of FIG. 1 connected to an A.C. adapter and a portable music player device; and

FIG. 4 is a schematic view showing the embodiment of FIG. 1 connected to a lap top computer and a portable music player device.

### DETAILED DESCRIPTION OF THE PREFERRED EMBODIMENT

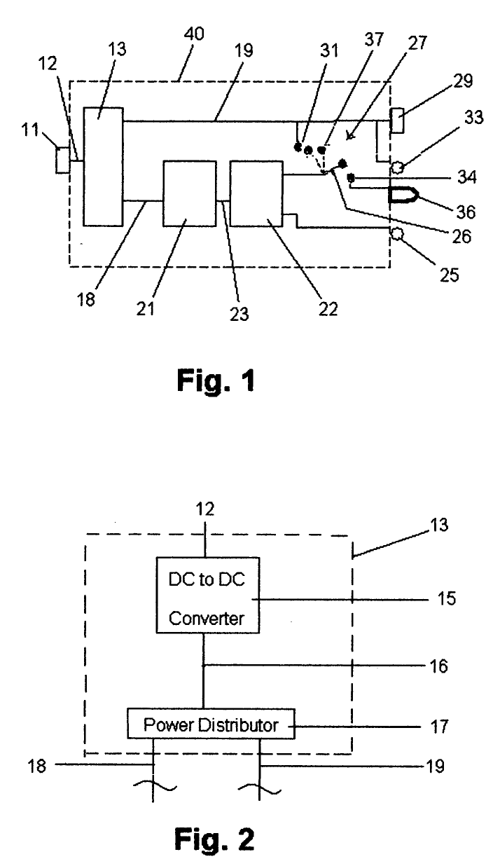

Turning now to the drawings, FIG. 1 is a block diagram illustrating the preferred embodiment of the invention. As seen in this Fig., the preferred embodiment includes an input power connector 11 for connection to a suitable external D.C. power source, which supplies input voltage in the range from about eight to about forty volts D.C. The output of connector 11 is coupled via conductors 12 to the input of a converter/transformer circuit 13 shown in FIG. 2.

With reference to FIG. 2, converter/transformer circuit 13 comprises a D.C. to D.C. converter 15 of conventional design capable of converting input D.C. voltages lying within the range noted above to a regulated output D.C. voltage of twelve volts D.C. The output of converter 15 is coupled via conductors 16 to the input of a power distributor 17, which splits the electrical power output from converter 15 into two parallel paths on conductors 18 and 19. Each path provides electrical power at twelve volts, 500 milliamps.

Returning to FIG. 1, the electrical power on path 18 is applied to a first one 21 of two rechargeable batteries 21, 22. Batteries 21, 22 are connected in series via conductors 23. One terminal of battery 22 is connected to a visible indicator 25, preferably a green LED. Another terminal of battery 22 is coupled to the movable contact 26 of a three position switch 27.

The electrical power on path 19 is coupled directly to a power output connector 29, and also to a first stationary contact 31 of switch 27. Path 19 is also coupled directly to a visible indicator 33, preferably an amber LED. Power output connector 29 provides D.C. electrical power to an associated portable electronic device by means of a standard connection cable (described below).

A second stationary contact 34 of switch 27 is coupled directly to a high intensity light source 36, preferably a type T-1 3/4/white LED available from Ultra Bright Corporation.

A third stationary contact 37 of switch has no connection and is used for the OFF position of the invention.

All of the elements described above are contained within or carried by a suitable enclosure housing which is illustrated in broken lines in FIG. 1 and designated by reference numeral 40.

In use, with power applied to input connector 11 from an external source and the movable contact 26 of switch 27 placed in contact with any of the stationary connectors 31, 34, 37, batteries 21, 22 are charged by the incoming current from the current/transformer circuit 13. The charging indicator 25 is illuminated during the charging process. When batteries 21, 22 are fully charged, indicator 25 is extinguished.

If the associated portable electronic device is connected to output connector 29 by means of a cable during the charging process, the current flowing along path 19 is transferred to the associated portable electronic device to charge the battery internal to the portable electronic device at the same time that the batteries 21, 22 are being charged, due to the action of the current/transformer circuit 13. In addition, the portable electronic device can be turned on to actively function by enabling telephone communication, data exchanges, music play or downloading, etc. Consequently, the invention functions to both charge the battery pack batteries 21, 22 and to provide power to the battery internal to the associated portable electronic device.

In another mode of operation, with no external power applied to input power connector 11 and the movable contact 26 of switch 27 placed in contact with stationary contact 31 (the Discharge position), electrical power is supplied from batteries 21, 22 to an associated portable electronic device when connected to power output connector 29 to charge the battery internal to the portable electronic device and provide extended active use time. In the preferred embodiment, up to an additional fourteen hours of playing time is afforded by the invention when connected to a portable music player. During this Discharge mode of operation, the indicator 33 is illuminated.

In still another mode of operation, with movable contact 26 placed in contact with stationary contact 34 of switch 27 (the Flashlight position), electrical power is applied from batteries 21, 22 to high intensity indicator 36, which functions as a flashlight to illuminate the area near the unit. Thus, the invention incorporates the useful additional feature of a hand-held flashlight, using the same batteries used to power the associated portable electronic device.

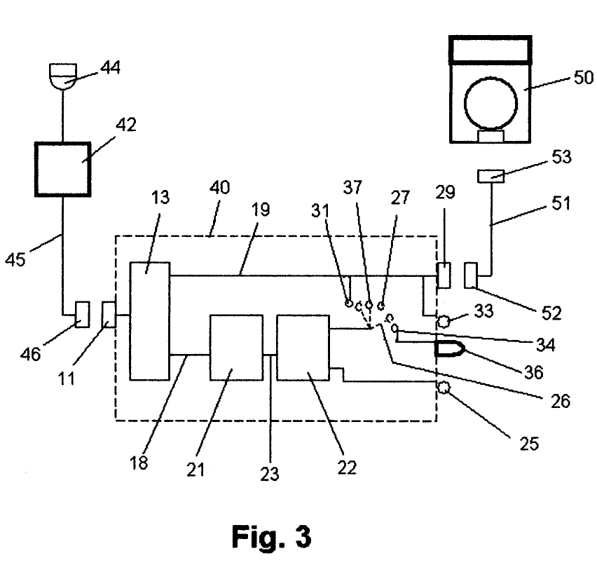

As noted above, electrical power must be supplied to the invention from an external source. FIG. 3 illustrates one configuration of the invention using a standard A.C. to D.C. adapter. As seen in this Fig., a conventional A.C. to D.C. adapter 42 has an A.C. plug 44 adapted to be connected with a standard A.C. power receptacle (not shown). Adapter 42 has a cable 45 terminating in an IEEE 1394 six pin connector 46. Connector 46 mates with input power connector 11.

Also illustrated in FIG. 3 is the power connection between the invention and an associated music player device. In FIG. 3, the music player device is a mobile hand held iPOD device having a twenty pin input connector available from Apple Computer Corp. The power connection is provided by a cable 51 having an IEEE 1394 six pin connector 52 at one end which mates with power output connector 29; and a twenty pin connector 53 at the other end which mates with the input connector to the Apple device.

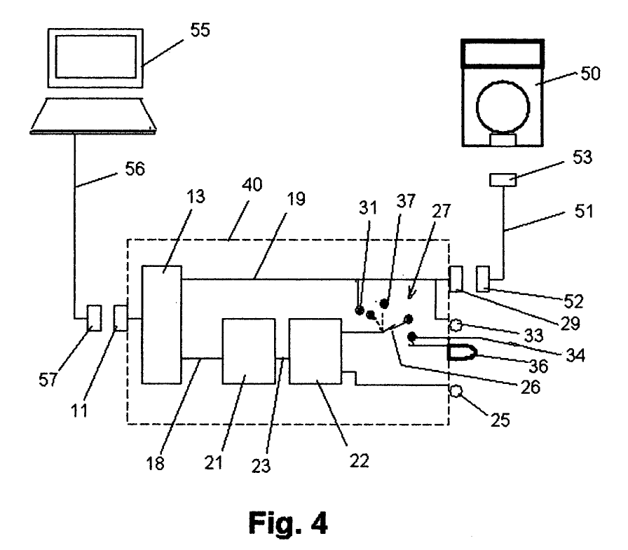

FIG. 4 illustrates another configuration of the invention in which the source of external power is a personal computer, such as an Apple Macintosh lap top computer 55. In this configuration, power input connector 11 is connected to the power connector of the computer 55 by means of a cable 56 having an IEEE 1394 six pin connector 57 which connects to connector 11 as shown. The power output connections are the same as those described above with reference to FIG. 3.

As will now be apparent, the invention provides additional electrical power to an associated portable electronic device for multiple purposes of charging the battery internal to the portable electronic device and supplementing the power provided by the battery internal to the portable electronic device. Thus, the invention affords an external, supplemental recharging capability, as well as extended active use time for the associated portable electronic device by virtue of the additional electrical power stored in batteries 21, 22. In addition, the invention provides the ancillary capability of a hand held flashlight using the same batteries used to power the associated portable electronic device.

Although the above provides a full and complete disclosure of the preferred embodiment of the invention, various modifications, alternate constructions and equivalents will occur to those skilled in the art. For example, although the invention has been described with specific reference to an iPOD portable music player in the specific embodiments of FIGS. 3 and 4, it has wider application to any type of portable electronic device which has a power input port for receiving external electrical power for recharging internal batteries. It is further noted that, although power input connector has been illustrated and described as being located at a different end of housing 40 from elements 25, 29, 33, and 36, in practice all these elements are preferably located on a single housing surface for the convenience of the user. Alternatively, connectors 11, 29 can be located on one common housing surface, while indicators 25 and 33 and high intensity LED 36 can be located on one or more other housing surfaces. Therefor, the above should not be construed as limiting the invention, which is defined by the appended claims.

What is claimed is:

1. A combination supplemental battery pack and battery charger unit for use with an associated portable electronic device having an electrical power input, said unit comprising:
a power input connector adapted to be coupled to an external source of electrical power;
a power output connector adapted to be coupled to a power input of an associated portable electronic device;
a converter/transformer circuit coupled to said power input connector for converting D.C. power received by said power input connector and varying over a preselected D.C. voltage range to D.C. voltage lying within a preselected narrow voltage range;
a first conductive path extending between said converter/transformer circuit and said power output connector;
a switch having a movable contact and three stationary contacts, a first one of said three stationary contacts being connected to said first conductive path, a second one of said three stationary contacts being an open connection;
a second conductive path coupled to said converter/transformer circuit; and
a rechargeable battery having an input connected to said second conductive path so that said rechargeable battery can be recharged when external power is applied to said power input connector, and an output coupled to said movable contact of said switch;
said rechargeable battery being connected to said power output connector when said movable contact of said switch is placed in contact with said first one of said three stationary contacts to provide supplemental D.C. electrical power to an associated portable electronic device connected to said power output connector, and said rechargeable battery being disconnected from said power output connector when said movable contact of said switch is placed in contact with said second one of said three stationary contacts.

2. The invention of claim 1 further including a visible indicator coupled to said first conductive path for providing a visible indication when electrical power is flowing to said power output connector.

3. The invention of claim 2 wherein said visible indicator is an LED.

4. The invention of claim 3 wherein said LED is an amber colored LED.

5. The invention of claim 1 further including a visible indicator coupled to said rechargeable battery for providing a visible indication when said rechargeable battery is undergoing recharge.

6. The invention of claim 5 wherein said visible indicator is an LED.

7. The invention of claim 6 wherein said LED is a green colored LED.

8. The invention of claim 1 further including a high intensity light source coupled to a third one of said three stationary contacts of said switch to function as a flashlight when said movable contact of said switch is placed in contact with said third stationary contact to connect said rechargeable battery to said high intensity light source.

9. The invention of claim 8 wherein said high intensity light source comprises an LED.

10. The invention of claim 1 wherein said portable electronic device is a portable music player.
